(19) United States
(12) Patent Application Publication
(10) Pub. No.: US 2011/0105029 A1
(43) Pub. Date: May 5, 2011

(54) COMMUNICATION TERMINAL APPARATUS, SOFTWARE ACQUIRING METHOD, AND RECORDING MEDIUM

(75) Inventors: Yukio TAKAYASHIKI, Kawasaki-shi (JP); Takafumi IMUKAI, Tokyo (JP); Fumiyoshi TOMOHARA, Kawasaki-shi (JP); Hideto ITOU, Kawasaki-shi (JP); Manabu TOYODA, Kawasaki-shi (JP); Osamu HAMAUE, Kawasaki-shi (JP); Shinichi KURANARI, Fukuoka-shi (JP); Akira TOKUNAGA, Fukuoka-shi (JP)

(73) Assignee: FUJITSU LIMITED, Kawasaki-shi (JP)

(21) Appl. No.: 12/938,420

(22) Filed: Nov. 3, 2010

(30) Foreign Application Priority Data
Nov. 4, 2009 (JP) 2009-253511
Oct. 28, 2010 (JP) 2010-242842

(51) Int. Cl. H04W 4/00

(52) U.S. Cl. 455/41.2

(57) ABSTRACT

A communication terminal apparatus including a second apparatus having a communication function and a first apparatus connectable to the second apparatus. The communication terminal apparatus includes an external communication function unit that is disposed in the second apparatus and acquires software, which is executable in the first apparatus, from an outside, a second memory that is disposed in the second apparatus and stores the software which is acquired, a first memory that is disposed in the first apparatus, and storage unit that is disposed in the first apparatus and stores the software read out from the second memory to the first memory according to a connection between the first apparatus and the second apparatus.

### CROSS-REFERENCE TO RELATED APPLICATIONS

This application is based upon and claims the benefit of priority of the prior Japanese Patent Application No. 2009-253511, filed on Nov. 4, 2009, and the Japanese Patent Application No. 2010-242842, filed on Oct. 28, 2010, the entire contents of which are incorporated herein by reference.

### FIELD

The embodiments discussed herein are related to technology such as acquiring and updating/adding software of a communication terminal apparatus wirelessly connecting parent and child devices in a separated state through wireless communication, such as a separate type portable telephone separated into a parent device and a child device.

### BACKGROUND

Since separated first communication apparatus (child device) and second communication apparatus (parent device) are wirelessly connected through a short-range communication technique in a communication terminal apparatus such as a separate type portable telephone, software is included that is for implementing communication between the both devices and individual functions. The version number of the software must be identical between the parent and child devices.

For the software update of a communication terminal apparatus other than such a separate type, it is known that software necessary for communication located in storage means is updated based on an instruction from a management center (Japanese Laid-Open Patent Publication No. 09-190353).

For rewriting a control program, it is known that a license key is received after authentication by a center server to rewrite the control program with a version upgrading program decoded by using the license key (Japanese Laid-Open Patent Publication No. 2002-271261).

For updating a firmware program, it is known that a firmware updating program is implemented in a portable terminal apparatus to automatically update the firmware program by receiving an updating firmware module delivered from a firmware delivery server (Japanese Laid-Open Patent Publication No. 2003-209510).

Ina communication terminal apparatus other than the separate type (Japanese Laid-Open Patent Publications Nos. 09-190353, 2002-271261 and 2003-209510), a software included in the communication terminal apparatus is merely updated. Since a parent device and a child device do not exist in a communication terminal apparatus not separated into the parent device and the child device, a difference in the software version number is not generated between the parent and child devices.

A separate type communication terminal apparatus performs short-range communication between separated parent and child devices, for example. If the parent device uses an update file acquired from the outside to update the existing software, the software of the child device is also updated at the same time to match the both version numbers. However, if the software of the parent device is updated while the parent device and the child device are separated and the child device is placed outside the short-range communication area of the parent device, communication is not performed from the parent device to the child device. Therefore, the software of the child device is not updated and a difference is generated in the software version numbers of the parent device and the child device. In such a case, when the parent device and the child device are connected, a trouble may occur in operation and function.

### SUMMARY

According to an aspect of the embodiment a communication terminal apparatus includes a second apparatus having a communication function and a first apparatus connectable to the second apparatus. The first apparatus obtains executable software.

The second apparatus includes an external communication function unit and a second memory. The second apparatus acquires software executable in the first apparatus from the outside and stores the acquired software into the second memory.

The first apparatus includes a unit that stores the software read out from the second memory to the first memory according to the connection between the first apparatus and the second apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

Other objects, features and advantages of the present disclosure will become more apparent by reference to the accompanying drawings and embodiments.

### BRIEF DESCRIPTION OF DRAWINGS

FIG. 1 is a diagram of an example of functional units of a communication terminal apparatus according to a first embodiment;

FIG. 2 is a flowchart of an example of a process procedure of software update;

FIG. 3 is a diagram of an example of functional units of a communication terminal apparatus according to a second embodiment;

FIG. 4 is a flowchart of an example of a process procedure of software update;

FIG. 5 is a diagram of an example of functional units of a communication terminal apparatus according to a third embodiment;

FIG. 6 is a diagram of an example of functional units of a parent device;

FIG. 7 is a diagram of an example of functional units of a child device;

FIG. 8 is a diagram of an example of hardware of a separate type portable telephone;

FIG. 9 is a diagram of an example of the separate type portable telephone;

FIG. 10 is a diagram of the separate type portable telephone with the child device slid;

FIG. 11 is a diagram of the separate type portable telephone viewed from the rear side with the child device slid;

FIG. 12 is a diagram of the separate type portable telephone viewed from the lateral side with the child device slid;

FIG. 13 is a diagram of the parent device and the child device in the separated state;

FIG. 14 is a diagram of the parent device in the separated state viewed from the rear side;

FIG. 15 is a diagram of the child device viewed from the top side with a slide housing unit of the child device slid;

FIG. 16 is a diagram of the child device viewed from the lateral side with the slide housing unit of the child device slid;

FIG. 17 is a diagram of pin assignment of contacts between the parent and child devices;

FIG. 18 is a diagram of message display of a displaying unit;

FIG. 19 is a flowchart of an example of a software updating function;

FIG. 20 is a flowchart of an example of a software updating function according to a fourth embodiment;

FIG. 21 is a flowchart of another example of a software updating function;

FIG. 22 is a diagram of message display of a displaying unit;

FIG. 23 is a diagram of a personal digital assistant;

FIG. 24 is a diagram of a separate type telephone;

FIG. 25 is a diagram of an example of functional units of a communication terminal apparatus according to a fifth embodiment;

FIG. 26 is a flowchart of an example of a software updating function; and

FIG. 27 is a diagram of an example of hardware of a separate type portable telephone.

### DESCRIPTION OF EMBODIMENTS

### First Embodiment

A first embodiment may be configured to automatically update software of a child device as a first apparatus of a communication terminal apparatus having a parent device as a second apparatus and the child device detachably separated to achieve wireless connection through short-range communication in a separated state and wired connection in a joined state. The “wired connection” used in embodiments in this Specification means connection in a form of physically connecting the parent device and the child device such as a terminal-to-terminal connection and the connection other than the wireless connection is referred to as a “wired connection” for convenience of description.

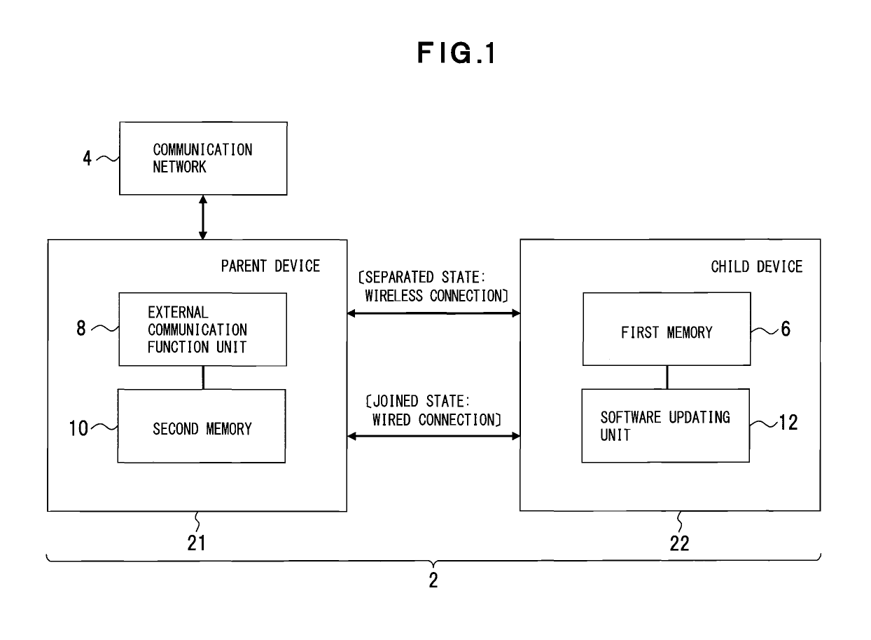

The first embodiment will be described with reference to FIG. 1. FIG. 1 depicts functional units of the communication terminal apparatus. The configuration depicted in FIG. 1 is an example and the present disclosure is not limited to this configuration.

A communication terminal apparatus 2 is an example of a communication terminal apparatus of this disclosure and, as depicted in FIG. 1, a parent device 21 which is an example of a second apparatus and a child device 22 which is an example of a first apparatus may be detachably separated. In the separated state, the parent device 21 and the child device 22 achieve a wireless connection through short-range wireless communication, and in the joined state, the parent device 21 and the child device 22 achieve a wired connection.

The parent device 21 is mainly assigned with a communication function for communication via a communication network 4, a display function, etc., and the child device 22 is mainly assigned with a phone call function, a key operation function, etc.

The communication terminal apparatus 2 includes a first memory 6, an external communication function unit 8, a second memory 10 and a software updating unit 12. In this embodiment, the child device 22 includes the memory 6 and the software updating unit 12 and the parent device 21 includes the external communication function unit 8 and the memory 10.

The memory 6 is means included in the childe device 22 to store software for the child device 22 communicating with the parent device 21.

The external communication function unit 8 is means included in the parent device 21 to acquire an update file related to the above software from the outside. The memory 10 is means that stores the acquired update file.

The software updating unit 12 is an example of means that acquires and updates the above software based on the update file read from the memory 10 when the parent device 21 acquires the update file and the parent device 21 and the child device 22 are connected.

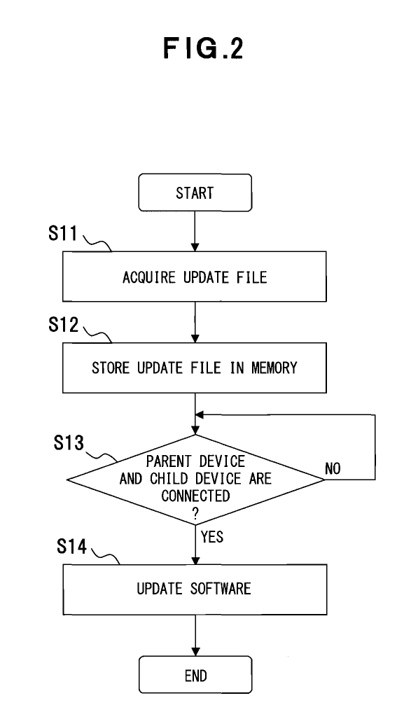

A process procedure of the software update will be described with reference to FIG. 2. FIG. 2 is a flowchart of an example of a process procedure of the software update.

This process procedure is an example of execution of a software acquiring method or a software acquiring program of this disclosure. As depicted in FIG. 2, this process procedure includes an update file acquiring function (step S11), an update file storage function (step S12), a connection checking function (step S13) and a software updating function (step S14).

The memory 6 of the child device 22 stores software for communicating with the parent device 21 in accordance with the software updating function. The parent device 21 acquires an update file from the outside through the external communication function unit 8 (step S11) and stores the update file into the memory 10 (step S12).

After the update file is acquired, it is determined whether the parent device 21 and the child device 22 are connected (step S13) and if the parent device 21 and the child device 22 are not connected (NO at step S13), the connection is continuously monitored.

If the parent device 21 and the child device 22 are connected (YES at step S13), the update file is read from the memory 10 and the software of the child device 22 is updated based on the update file (step S14).

With this configuration, by joining the parent device 21 having software updated and the child device 22 having the software not updated, the software becomes identical between the parent device 21 and the child device 22 through the automatic update of the software of the child device 22. Even when the version number of the software of the child device 22 retained by the parent device 21 is not identical to the version number of the software of the child device 22, if the child device 22 is joined to the parent device 21, the software of the child device 22 can be updated. The software update of the parent device 21 can freely be executed while the child device 22 is separated and the automatic update of the software of the child device 22 can be triggered by the joining to the parent device 21. An inconvenience such as having trouble with software update of the child device 22 is eliminated.

In the separate type communication terminal apparatus 2 like the above, if the software of the parent device is updated while the parent device and the child device is separated and the child device is placed outside the short-range communication area of the parent device, communication is not performed from the parent device to the child device. Therefore, although the software of the child device is not updated and a difference is generated in the software version numbers of the parent device and the child device, such a difference in the version numbers can be eliminated and an inconvenience such as a trouble occurring in operation and a function can be eliminated. Therefore, the reliability can be enhanced in the operation of the separate type communication terminal apparatus 2.

According to the first embodiment, the following effects are acquired.

(1) The parent device 21 (second apparatus) acquires software executable in the child device 22 (first apparatus) and can provide the acquired software for the child device 22. Thereby, the convenience of acquiring and updating software can be enhanced.

(2) The parent device 21 acquires software executable in the child device 22 to save the acquired software into the memory 10 and can provide the software for the child device 22 according to the connection between the parent and child devices. Thereby, the convenience of acquiring and updating software can be enhanced.

(3) The communication terminal apparatus 2 of its enhanced convenience of acquiring and updating software can be implemented to be provided.

(4) Even when the software update of the parent device 21 is executed while being separated from the child device 22, if the child device 22 is joined to the parent device 21, the update file is transferred to the child device 22 and the software of the child device 22 can be updated.

(5) If the software update of the parent device 21 is executed while being separated from the child device 22, a software version number difference between the parent device 21 and the child device 22 can be eliminated.

### Second Embodiment

A second embodiment may be configured to automatically update the software of the child device after checking the version number of the software of the child device and checking the connection on the parent device side.

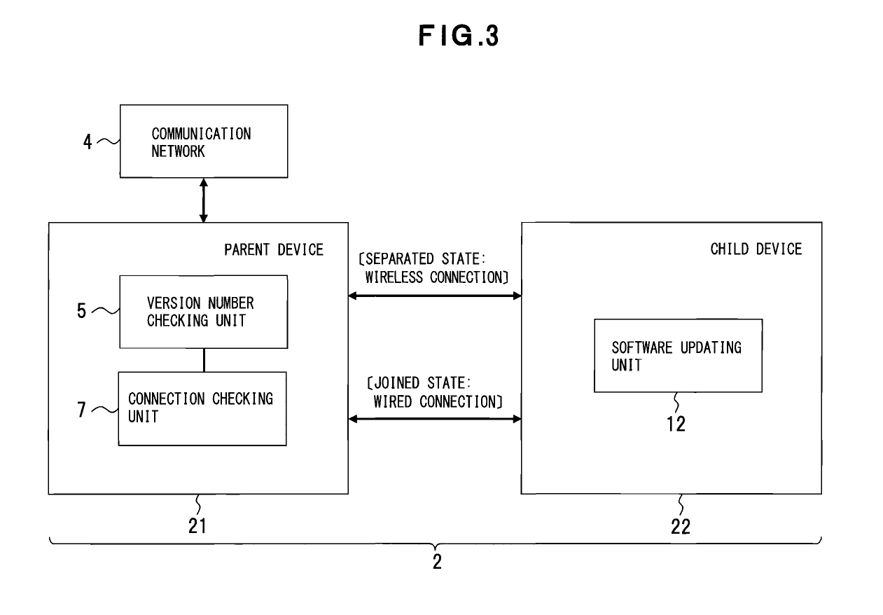

The second embodiment will be described with reference to FIG. 3. FIG. 3 depicts functional units of a communication terminal apparatus. The configuration depicted in FIG. 3 is an example and the present disclosure is not limited to this configuration.

In this embodiment, the parent device 21 and the child device 22 may be detachably separated; the parent device 21 and the child device 22 achieve a wireless connection through short-range wireless communication in the separated state; and the parent device 21 and the child device 22 achieve a wired connection in the joined state, too. The function assignments to the parent device 21 and the child device 22 are the same as the first embodiment.

In this embodiment, the parent device 21 includes a version number checking unit 5 and a connection checking unit 7. The version number checking unit 5 is an example of a functional unit that checks whether the version number of the software of the child device 22 is different from the version number retained by the parent device 21. The software version number check is performed by checking version number information and, for example, version number data of update file data of the child device 22 saved by the parent device 21 is compared with version number data received from the child device 22 to determine whether the version number is identical or not. That is, in the version number checking unit 5, the version number of the existing software which corresponds to newly acquired software and has been retained by the child device 22 is compared with the version number of the existing software which corresponds to the newly acquired software and has been retained by the parent device 21.

The connection checking unit 7 is an example of a functional unit that checks whether the child device 22 is connected to the parent device 21. Since the parent device 21 and the child device 22 achieve the wired connection when joined and achieve the wireless connection when separated, the connection may be determined depending on whether joined or separated.

The child device 22 includes the software updating unit 12. The software updating unit 12 is an example of a functional unit that connects the child device 22 to the parent device 21 to update the software of the child device 22. If the version number of the software of the child device 22 is different from the version number of the software of the parent device 21, when the child device 22 is connected to the parent device 21, the parent device 21 provides an update file data to the child device 22. The child device 22 updates the software with the provided update file data. That is, in the software updating unit 12, software is updated according to the comparison result by the version number checking unit 5. Thereby, the version number of the software in the child device 22 is updated to the version number of the software in the parent device 21.

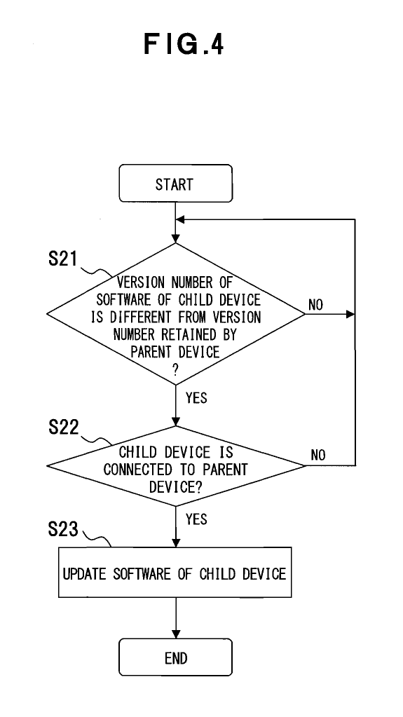

A process procedure of the software update will be described with reference to FIG. 4. FIG. 4 is a flowchart of an example of a process procedure of the software update.

The process procedure is an example of the software acquiring method or the software acquiring program of this disclosure. As depicted in FIG. 4, this process procedure includes a version number checking function (step S21), a connection checking function (step S22) and a software updating function (step S23).

The version number check is performed by checking whether the version number of the software of the child device 22 is different from the version number retained by the parent device 21 (step S21). At the time of the version number check, for example, the parent device 21 may request the child device 22 to check the version number and the parent device 21 may receive the version number data from the child device 22 through the wired connection in the case of the joined state between the parent device 21 and the child device 22 and through the wireless connection in the case of the separated state. If the version number of the software is not different, i.e., is identical (NO at step S21), the software is not updated. If the version number of the software is different, i.e., is not identical (YES at step S21), the procedure goes to the connection check (step S22).

The connection check is performed by checking whether the child device 22 is connected to the parent device 21 (step S22). In this case, if the software is updated through the wired connection, the connection check may be performed by checking the wired connection. If the software can be updated through the wireless connection, the connection check may be performed for either the wired connection or the wireless connection. The wired connection may be checked by detecting switch-on/off or an electric potential to check whether the child device 22 is joined to the parent device 21. If the parent device 21 and the child device 22 are not connected (NO at step S22), the software is not updated. If the parent device 21 and the child device 22 are connected (YES at step S22), the procedure goes to the software update at this timing (step S23).

The software update is executed by updating the software of the child device 22 when the version number of the software of the child device 22 is different from the version number retained by the parent device 21 and the child device 22 is connected to the parent device 21.

With this configuration, in this embodiment, even when the version number of the software of the child device 22, retained by the parent device 21, is not identical to the version number of the software of the child device 22, if the child device 22 is joined to the parent device 21, the software of the child device 22 can be updated. The software update of the parent device 21 can freely be executed while the child device 22 is separated and the automatic update of the software of the child device 22 can be triggered by the joining to the parent device 21. An inconvenience such as having trouble with software update of the child device 22 is eliminated.

If the software update of the parent device 21 is performed while the child device 22 is separated, a version number difference in the software of the parent device 21 and the child device 22 can be eliminated. As a result, the functional disorder etc., can be prevented from occurring due to a version number difference in the software of the parent device 21 and the child device 22 and the reliability can be enhanced in the operation of the communication terminal apparatus 2 having the parent device 21 and the child device 22 used in the separated or joined state.

### Third Embodiment

In a configuration of a third embodiment, when software of a parent device is updated, software of a child device maybe automatically updated at the timing of connection with the child device after the version number check with the child device.

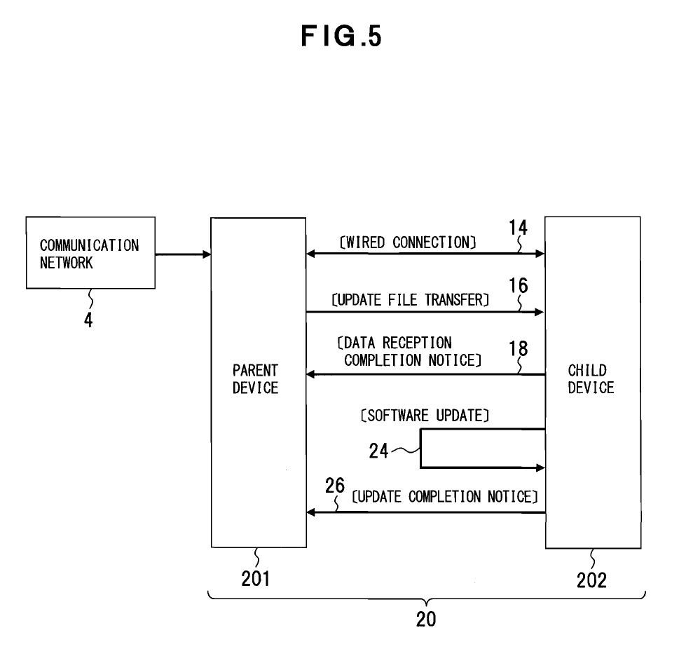

The third embodiment will be described with reference to FIG. 5. FIG. 5 depicts a software updating function of a separate type portable telephone. The configuration depicted in FIG. 5 is an example and the present invention is not limited to this configuration.

A separate type portable telephone 20 is an example of a communication terminal apparatus of this disclosure and may be separated into a parent device 201 and a child device 202, which are detachable. The parent device 201 is mainly assigned with a communication function for communication via a communication network 4, a display function, etc., and the child device 202 is mainly assigned with a phone call function, a key operation function, etc.

In this case, the parent device 201 is connected to the communication network 4 and can receive the provision of software from the communication network 4 to update its own software independently of the child device 202. This update of software generates a difference in the version number, i.e., a version number difference, from the software of the child device 202.

This separate type portable telephone 20 additionally has a software updating function for the child device 202 and retains an update file of the child device 202 received by the parent device 201 as a portion of data of the parent device 201 to use this update file for the software update of the child device 202.

In this child device software updating function, when the parent device 201 and the child device 202 achieve a wired connection, this wired connection 14 triggers execution of the child device software updating function. In this case, if the version number of the software of the child device 202 is not identical to the version number retained by the parent device 201, an update file transfer 16 is executed from the parent device 201 to the child device 202. The child device 202 receives the transfer of the update file from the parent device 201 and stores the update file into a storage unit. The child device 202 generates a data reception completion notice 18 and supplies the generated data reception completion notice 18 to the parent device 201.

The child device 202 executes a software update 24 based on the transferred update file. After the software update 24 is completed, an update completion notice 26 is generated in the child device 202 and supplied to the parent device 201.

When the child device 202 in a state of executing the software update 24 turns to a software update mode at the timing of the update file transfer 16, the parent device 201 stops giving instructions from the parent device 201 to the child device 202 and maintains a state of preventing an external event from occurring. The software update of the child device 20 is executed as a priority process. In this case, the state of preventing an external event from occurring means, for example, stopping a functional process such as key input. This enhances the reliability of the software update.

The child device 202 cancels the software update mode in association with the generation of the update completion notice 26. When receiving the update completion notice 26 from the child device 202, the parent device 201 turns to a normal mode and executes a process of external event.

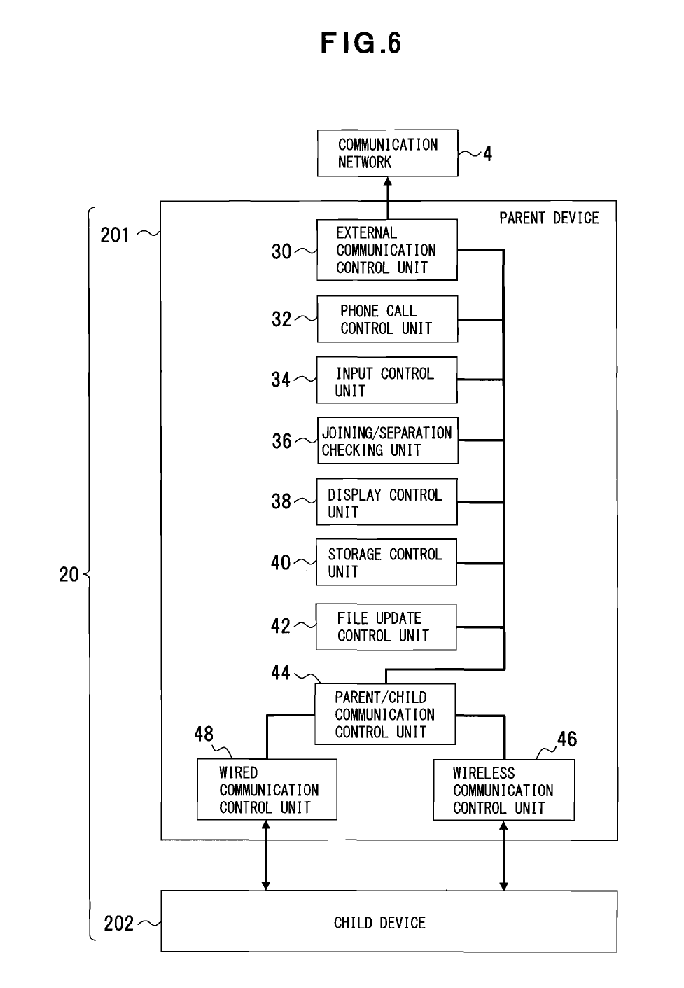

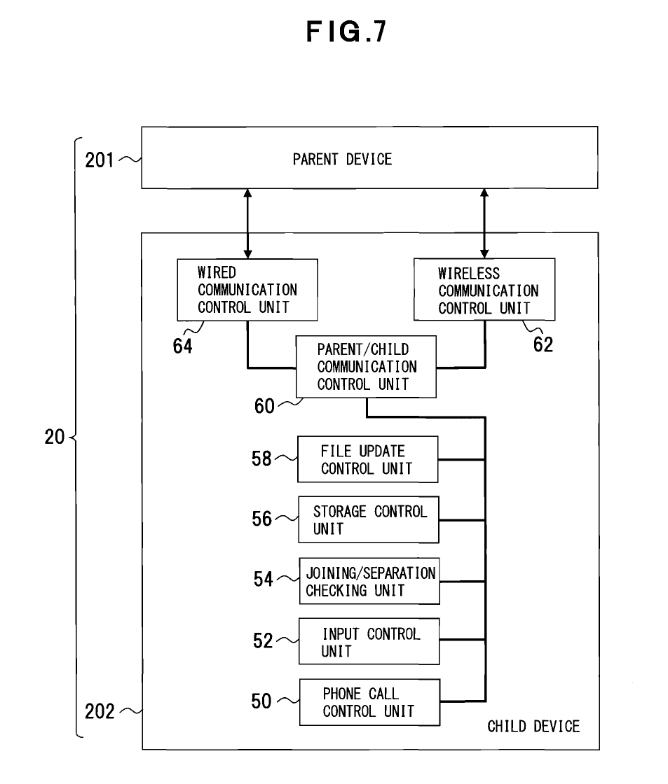

The functions of the separate type portable telephone will be described with reference to FIGS. 6 and 7. FIG. 6 depicts an example of functional units of the parent device of the separate type portable telephone and FIG. 7 depicts an example of functional units of the child device thereof.

A separate type portable telephone 20 executes an external communication function, a display function, etc., of the separate type portable telephone 20 mainly by the parent device 201 and executes a function of communicating with the parent device 201, a phone call function, an input operation function, etc., of the separate type portable telephone 20 mainly by the child device 202.

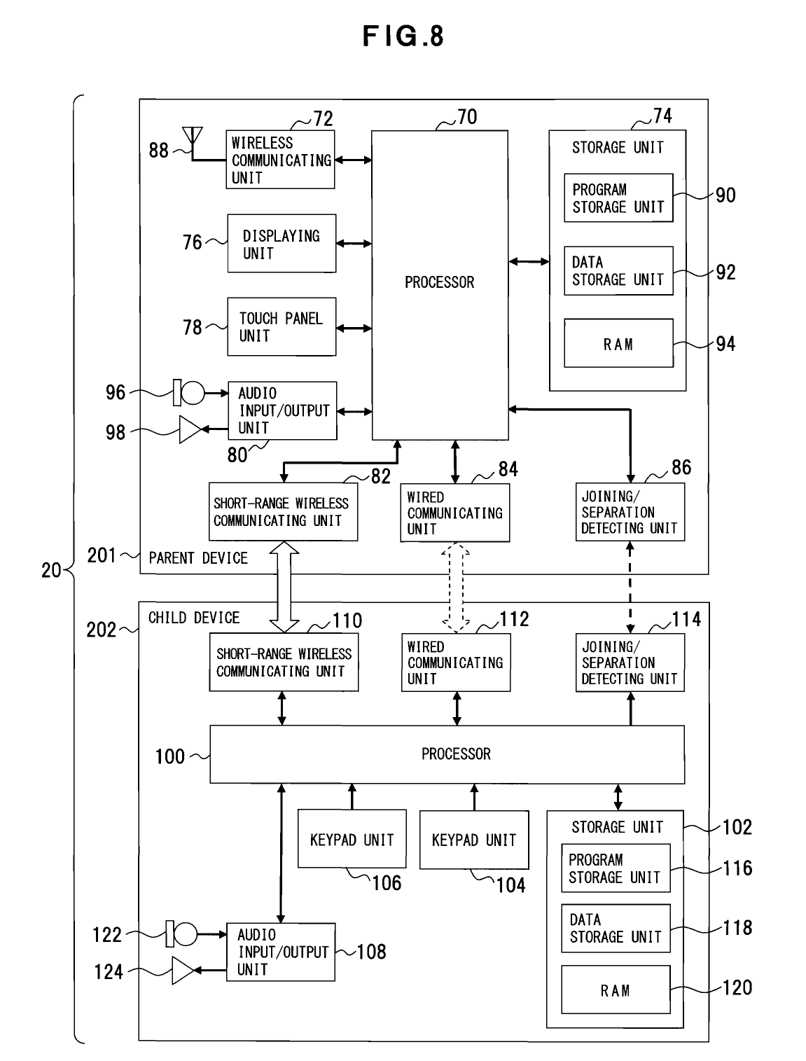

Therefore, as depicted in FIG. 6, the parent device 201 includes an external communication control unit 30, a phone call control unit 32, an input control unit 34, a joining/separation checking unit 36, a display control unit 38, a storage control unit 40, a file update control unit 42, a parent/child communication control unit 44, a wireless communication control unit 46 and a wired communication control unit 48. These functions are generated and executed by a computer (a processor 70, FIG. 8) mounted on the parent device 201.

The external communication control unit 30 is an example of an external communication functional unit, is wirelessly connected to the external communication network 4 to perform phone call and data communication, and has a function of receiving the provision of update data of the software of the parent device 201 and the child device 202 from the outside. Through the communication network 4, the parent device 201 is wirelessly connected to a base station and a server. The update data of the software of the parent device 201 and the child device 202 is provided from a data server, for example.

The phone call control unit 32 is a functional unit that uses the communication function on of the parent device 201 to make a phone call with a counterpart apparatus through the communication network 4.

The input control unit 34 is a functional unit that receives data input and selection input from a touch panel unit 78 (FIG. 8) disposed on a displaying unit 76 to recognize the input.

The joining/separation checking unit 36 is a functional unit that checks whether the parent device 201 is joined to or separated from the child device 202. The determination on whether the parent device 201 is joined to or separated from the child device 202 may be performed depending on the presence of the electric coupling state between the parent device 201 and the child device 202.

The display control unit 38 has a function of displaying information including a message display function. When update data of software arrives at the parent device 201 or when the software of the parent device 201 is updated, this triggers the message display function to display a message that prompts connection with the child device 202. The display control unit 38 is an example of a message output unit for outputting a message. In this case, a message prompting update of the software of the child device 202 may be displayed.

The storage control unit 40 is an example of data retaining means and is a functional unit that stores provided software and the version number data thereof. The storage control unit 40 stores and retains the software of the parent device 201, stores and retains the version number data of the software of the child device 202, and temporarily retains the software of the child device 202 provided from the outside.

The file update control unit 42 is an example of a software updating unit of the parent device 201 and includes a function of software update for the parent device 201. Functions such as version number verification, connection check, and waiting during software update of the child device 202 may also be included as the software update function for the child device 202. The version number verification is an example of the version number check and a version number check notice is generated at the timing of the provision of the software update data to the parent device 201 or the software update to verify the version number data transferred from the child device 202 against the version number data retained in the parent device 201. The connection check is a check of whether the child device 202 is connected to the parent device 201 before transmitting the update file to the child device 202. If the wired connection is used for the transmitting of the update file, it is checked whether the wired connection exists. If the parent device 201 turns to the data transfer mode, the process of external event is blocked.

The parent/child communication control unit 44 is a control functional unit that controls a communication form between the parent and child devices on the parent device 201 side and achieves the wired connection if the parent and child devices are in the joined state and the wireless connection if the parent and child devices are in the separated state.

The wireless communication control unit 46 is means for connection through a wireless medium such as a radio wave and, for example, the Bluetooth communication may be used for the wireless connection. The wired communication control unit 48 achieves connection through the joining between the parent and child devices.

As depicted in FIG. 7, the child device 202 includes a phone call control unit 50, an input control unit 52, a joining/separation checking unit 54, a storage control unit 56, a file update control unit 58, a parent/child communication control unit 60, a wireless communication control unit 62 and a wired communication control unit 64. These functions are generated and executed by a computer (a processor 100, FIG. 8) mounted on the child device 202.

The phone call control unit 50 is a functional unit that uses the communication function of the parent device 201 and the wireless connection function of the parent device 201 to make a phone call. If the wireless connection is achieved through the Bluetooth communication, a phone call with a counterpart apparatus is made through a base station by the communication function of the parent device 201.

The input control unit 52 is a functional unit that recognizes input from keypad units 104 and 106 (FIG. 8).

The joining/separation checking unit 54 is a functional unit that checks whether the child device 202 is joined to or separated from the parent device 201. The determination on whether the child device 202 is joined to or separated from the parent device 201 may be performed as described above depending on the presence of the electric coupling state between the parent device 201 and the child device 202.

The storage control unit 56 is an example of data retaining means and is a functional unit that stores software, the update file provided from the parent device 201, etc.

The file update control unit 58 is an example of a software updating unit and is a functional unit that updates the software of the child device 202 receiving the provision of the update file from the parent device 201. The function of the software update of the child device 202 is triggered by the parent device 201 turning to the data transfer mode and is started with the provision of the update file data. The software update includes generation of an update file reception notice, the software update, software update completion confirmation, deletion of the update file, and generation of a software update completion notice.

The parent/child communication control unit 60 is a control functional unit that controls a communication form between the parent and child devices on the child device 202 side and achieves the wired connection if the parent and child devices are in the joined state and the wireless connection if the parent and child devices are in the separated state.

The wireless communication control unit 62 is means for connection through a wireless medium such as a radio wave and, for example, the Bluetooth communication may be used for the wireless connection. The wired communication control unit 64 achieves connection through the joining between the parent and child devices as described above.

Hardware of the separate type portable telephone will be described with reference to FIG. 8. FIG. 8 depicts an example of the hardware of the separate type portable telephone.

The separate type portable telephone 20 detachably includes the parent device 201 and the child device 202 and includes a hardware configuration for implementing the functions described above. As depicted in FIG. 8, the parent device 201 includes the processor 70, a wireless communicating unit 72, a storage unit 74, the displaying unit 76, the touch panel unit 78, an audio input/output unit 80, a short-range wireless communicating unit 82, a wired communicating unit 84 and a joining/separation detecting unit 86.

The processor 70 executes programs in the storage unit 74 to generate the functional units described above (FIG. 6) to execute the functions. The processor 70 may be made up of CPU (central processing unit), for example.

The wireless communicating unit 72 is an example of an external communication functional unit, includes an antenna 88, and performs phone calls and data communication through the wireless communication with the above communication network 4 via a base station under the control of the processor 70.

The storage unit 74 is storage means that stores and retains various data such as programs under the control of the processor 70 and includes a program storage unit 90, a data storage unit 92 and a RAM (random-access memory) 94. The program storage unit 90 is made up of a recording medium and stores OS (operating system), firmware programs, application programs, the software updating program, etc. The data storage unit 92 is an example of a second memory that stores an update file and is storage means for data. The data storage unit 92 is made up of a nonvolatile memory that is a memory capable of retaining storage contents even if energization is canceled. The data storage unit 92 stores the version number data of the software of the parent device 201 and the child device 202, the update file of the software, etc. The RAM 94 makes up a work area for executing various data processes such as the software update of the parent device 201 and the child device 202.

The displaying unit 76 is an example of a message output unit and information presenting means and is made up of an LCD (liquid crystal display) display, for example. The displaying unit 76 performs various displays, such as message display prompting the update of the software of the child device 202 and message display prompting connection with the child device 202, under the control of the processor 70.

The touch panel unit 78 is an example of input means superimposed and disposed on the displaying unit 76 and is capable of giving instructions and inputting data through contact or press by a user's finger or a stylus in accordance with display on the displaying unit 76 under the control of the processor 70.

The audio input/output unit 80 is an example of input means and output means for sound and includes a microphone 96 and a receiver 98. The audio input/output unit 80 converts sound input to the microphone 96 into an electric signal to be input to the processor 70 and reproduces an audio output signal of the processor 70 as sound with the receiver 98 under the control of the processor 70.

The short-range wireless communicating unit 82 is wireless connecting means that wirelessly connects with the child device 202 and performs the communicating connection through the Bluetooth communication, for example. The short-range wireless communicating unit 82 achieves the wireless connection if the child device 202 is separated from the parent device 201.

The wired communicating unit 84 is wired connecting means that achieves the wired connection when the child device 202 is joined and achieves the wired connection through UART (universal asynchronous receiver transmitter) connection, for example.

The joining/separation detecting unit 86 is an example of means located on the parent device 201 side to detect whether the child device 202 is joined to the parent device 201 or the child device 202 is separated from the parent device 201 and is made up of a joining/separation detecting device, for example. The joining or separation maybe detected as the presence of joining between terminals depending on electric potential, for example. In this case, if the joining/separation detecting unit 86 detects the separated state between the parent device 201 and the child device 202, the wireless connection of the short-range wireless communicating unit 82 is triggered. If the joining/separation detecting unit 86 detects the joined state between the parent device 201 and the child device 202, the wired connection of the wired communicating unit 84 is triggered.

The child device 202 includes the processor 100, a storage unit 102, the keypad units 104 and 106, an audio input/output unit 108, a short-range wireless communicating unit 110, a wired communicating unit 112 and a joining/separation detecting unit 114.

The processor 100 executes programs in the storage unit 102 to generate the functional units described above (FIG. 7) to execute the functions. The processor 100 may be made up of, for example, CPU as is the case with the parent device 201.

The storage unit 102 is storage means that stores and retains various data such as programs under the control of the processor 100 and includes a program storage unit 116, a data storage unit 118 and a RAM 120. The program storage unit 116 is made up of a recording medium and stores software such as OS, firmware programs, application programs, a software update program. The data storage unit 118 is an example of a first memory that stores software for communicating with the parent device 201 and storage means for data. The data storage unit 118 is made up of a nonvolatile memory that is a memory capable of retaining storage contents even if energization is canceled. The data storage unit 118 stores the update file etc., of the software of the child device 202. The RAM 120 makes up a work area for executing various data processes such as software update of the child device 202.

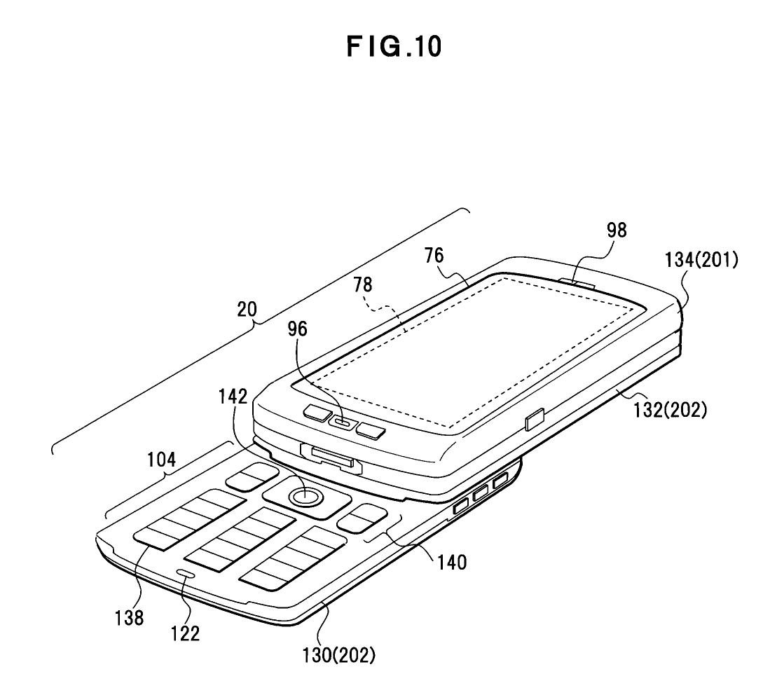

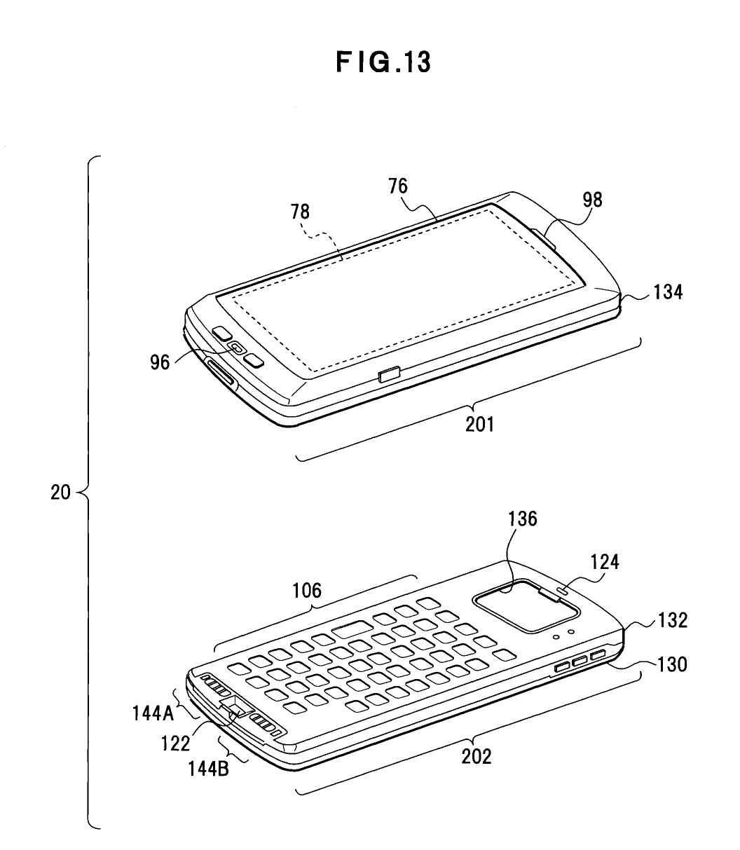

The keypad unit 104 is a first key input unit, is disposed on a fixed housing unit 130 (FIG. 10) of the child device 202, and includes symbol keys, a cursor key, a decision key, etc. The keypad unit 106 is a second key input unit, is disposed on a slide housing unit 132 (FIG. 13) located on the child device 202 side, appears when the child device 202 is separated from the parent device 201, and is superimposed on the keypad unit 104 and used for key input.

The audio input/output unit 108 is an example of input means and output means for sound and includes a microphone 122 and a receiver 124. When the child device 202 is separated from the parent device 201, the audio input/output unit 108 converts sound input to the microphone 122 into an electric signal to be input to the processor 100 and reproduces an audio output signal of the processor 100 as sound with the receiver 124 under the control of the processor 100.

The short-range wireless communicating unit 110 is wireless connecting means that wirelessly connects with the short-range wireless communicating unit 82 of the parent device 201 and performs the communicating connection through the Bluetooth communication, for example. The short-range wireless communicating unit 110 achieves the wireless connection if the child device 202 is separated from the parent device 201.

The wired communicating unit 112 is wired connecting means that achieves the wired connection when the parent device 201 is joined and achieves the wired connection through the above described UART connection.

The joining/separation detecting unit 114 is an example of means located on the child device 202 side to detect whether the child device 202 is joined to the parent device 201 or the child device 202 is separated from the parent device 201 and is made up of a joining/separation detecting device as described above, for example. The joining or separation may be detected as the presence of joining between terminals depending on electric potential, for example. As is the case with the parent device 201, if the joining/separation detecting unit 114 detects the separated state between the parent device 201 and the child device 202, the wireless connection of the short-range wireless communicating unit 110 is triggered. If the joining/separation detecting unit 114 detects the joined state between the parent device 201 and the child device 202, the wired connection of the wired communicating unit 112 is triggered.

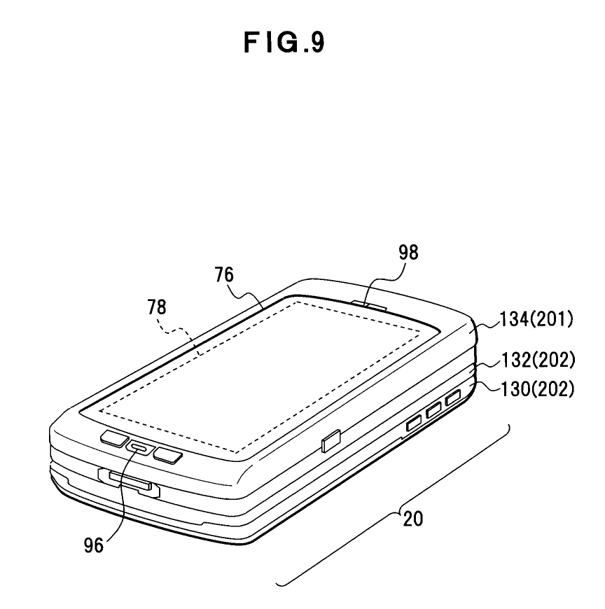

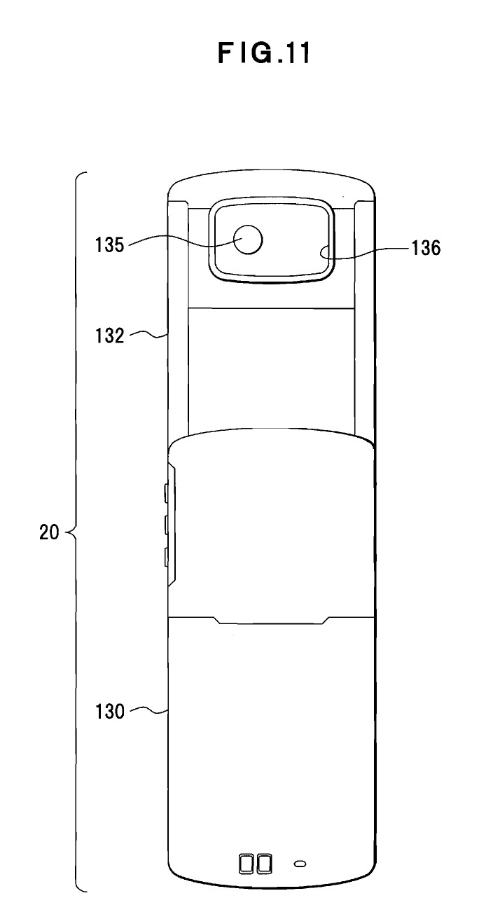

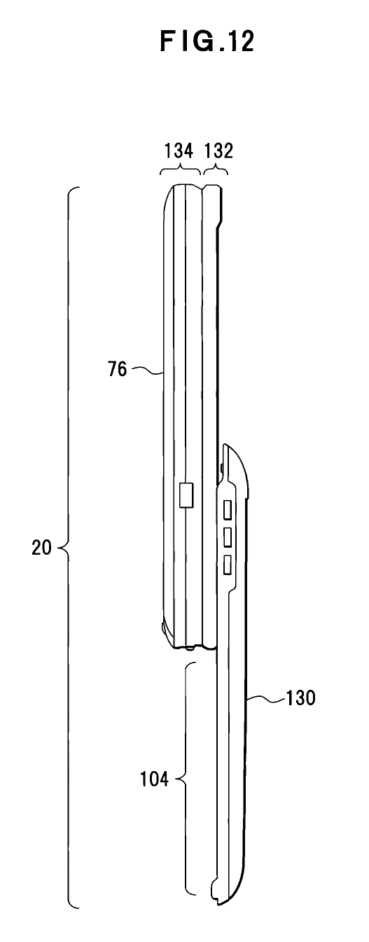

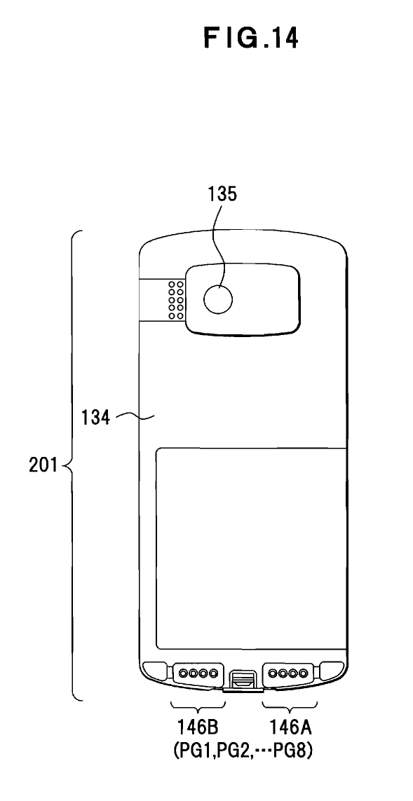

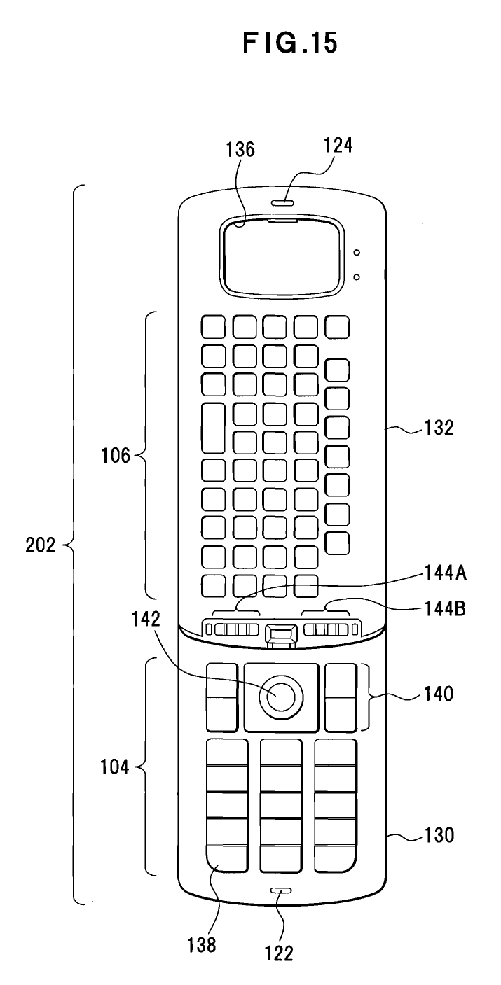

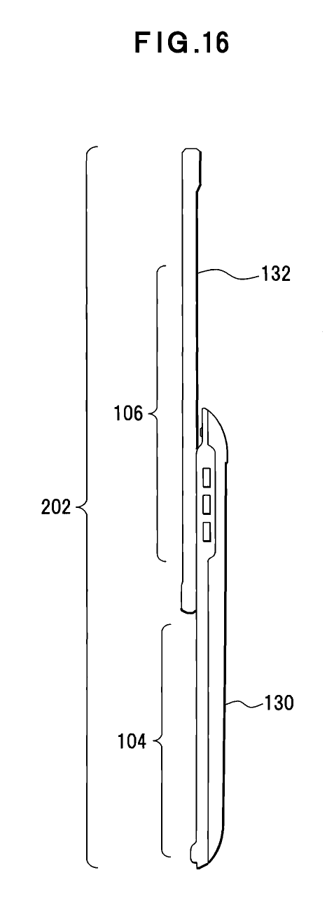

The separate type portable telephone will be described with reference to FIGS. 9, 10, 11, 12, 13, 14, 15, and 16. FIG. 9 depicts an example of the separate type portable telephone; FIG. 10 depicts the separate type portable telephone with the child device slid; FIG. 11 depicts the separate type portable telephone viewed from the rear side with the child device slid; FIG. 12 depicts the separate type portable telephone viewed from the lateral side with the child device slid; FIG. 13 depicts the parent device and the child device in the separated state; FIG. 14 depicts the parent device in the separated state viewed from the rear side; FIG. 15 depicts the child device viewed from the top side with a slide housing unit of the child device slid; and FIG. 16 depicts the child device viewed from the lateral side with the slide housing unit of the child device slid.

As depicted in FIG. 9, the separate type portable telephone 20 includes the fixed housing unit 130, the slide housing unit 132 and a movable housing unit 134. In this case, the fixed housing unit 130 and the slide housing unit 132 are used for the child device 202 and the movable housing unit 134 is used for the parent device 201.

On the fixed housing unit 130, as depicted in FIGS. 10 to 13, the slide housing unit 132 is disposed and made slidable in the longitudinal direction of the fixed housing unit 130 by a slide mechanism. The movable housing unit 134 is attached to and detached from the slide housing unit 132 by an attaching/detaching mechanism. Therefore, if the movable housing unit 134 is disposed on the slide housing unit 132, the movable housing unit 134 is slidable in the longitudinal direction of the fixed housing unit 130 with the slide housing unit 132. FIGS. 10, 11 and 12 depict the movable housing unit 134 slid together with the slide housing unit 132 and projected from the fixed housing unit 130. In this case, a camera unit 135 is disposed on the rear side of the movable housing unit 134 and the camera unit 135 is exposed from a window unit 136 in the slide housing unit 132.

When the slide housing unit 132 is matched with the fixed housing unit 130, the movable housing unit 134 can be joined to or separated from the fixed housing unit 130 as depicted in FIGS. 13 and 14. FIG. 14 depicts the rear side of the movable housing unit 134. When the movable housing unit 134 (parent device 201) is separated from the fixed housing unit 130, the upper surface of the fixed housing unit 130 is covered by the slide housing unit 132 and, as depicted in FIGS. 15 and 16, the slide housing unit 132 is slidable to shift in the longitudinal direction from the fixed housing unit 130.

With this configuration, the separate type portable telephone 20 includes the detachable and slidable parent device 201 and the child device 202 and, if the parent device 201 and the child device 202 are joined, the parent device 201 and the child device 202 are disposed on the upper surface side and the lower surface side, respectively. The movable housing unit 134 is disposed with the displaying unit 76 and the touch panel unit 78 along with the microphone 96 and the receiver 98.

The fixed housing unit 130 is disposed with the keypad unit 104 of the child device 202 along with the microphone 122. The slide housing unit 132 is disposed with the keypad unit 106 along with the receiver 124.

In the joined state, as depicted in FIG. 10, the movable housing unit 134 slides in cooperation with the slide housing unit 132 and, if the movable housing unit 134, i.e., the parent device 201 is slid, the keypad unit 104 of the child device 202 is exposed to enable key input operations. The keypad unit 104 is disposed with symbol keys 138, a cursor key 140, a decision key 142, etc.

If the movable housing unit 134 is separated from the fixed housing unit 130, the keypad unit 106 and the receiver 124 of the slide housing unit 132 are exposed on the fixed housing unit 130 as depicted in FIG. 13. The key input operation can be performed from the keypad unit 106 and a phone call can be made from the child device 202 through the parent device 201 via the Bluetooth communication.

As depicted in FIG. 13, the fixed housing unit 130 is disposed with connection terminal units 144A and 144B of the wired communicating unit 112 and, as depicted in FIG. 14, the movable housing unit 134 is disposed with connection terminal units 146A and 146B of the wired communicating unit 84. If the parent device 201 and the child device 202 are in the joined state, since an electric connection is achieved via the connection terminal units 144A-146A and 144B-146B, the joined state is detected by the joining/separation detecting units 86 and 114. The connection terminal units 144A-146A and 144B-146B are made up of a plurality of pins PG1, PG2, PG3 . . . PG8.

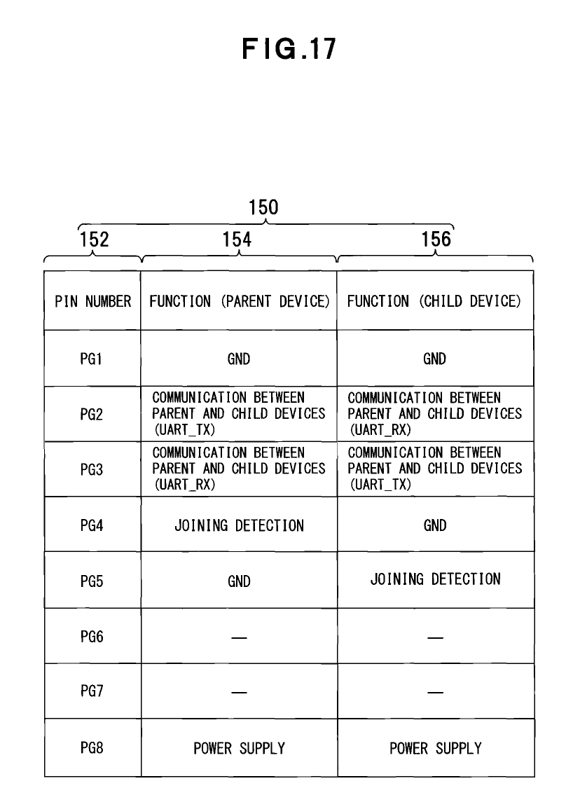

Pin assignment of contacts between the parent and child devices will be described with reference to FIG. 17. FIG. 17 depicts an example of a pin assignment table of the contacts between the parent and child devices.

This pin assignment table 150 is set with a pin number field 152, a parent device function field 154, and a child device function field 156 and is stored in the data storage units 92 and 118.

In this case, the pin number field 152 stores the numbers in an eight-pin configuration of PG1, PG2, PG3 . . . PG8 as the pin numbers corresponding to the pins making up the connection terminal units 144A, 144B, 146A and 146B. In this case, the pin PG1 is assigned to the ground (GND) in both the parent device 201 and the child device 202.

The pin PG2 is assigned to the wired communication between the parent and child devices, and UART-TX representative of the transmission side and UART-RX representative of the reception side are set in the parent device 201 and the child device 202, respectively. The pin PG3 is assigned to the wired communication between the parent and child devices, and UART-RX representative of the reception side and UART-TX representative of the transmission side are set in the parent device 201 and the child device 202, respectively.

Both the pins PG4 and PG5 are assigned to the joining detection; the pin PG4 is assigned to the joining detection in the parent device 201 and the ground (GND) in the child device 202; and the PG5 is assigned to the ground (GND) in the parent device 201 and the joining detection in the child device 202.

The pins PG6 and PG7 have no assignment and PG8 is assigned to the power supply in each of the parent device 201 and the child device 202.

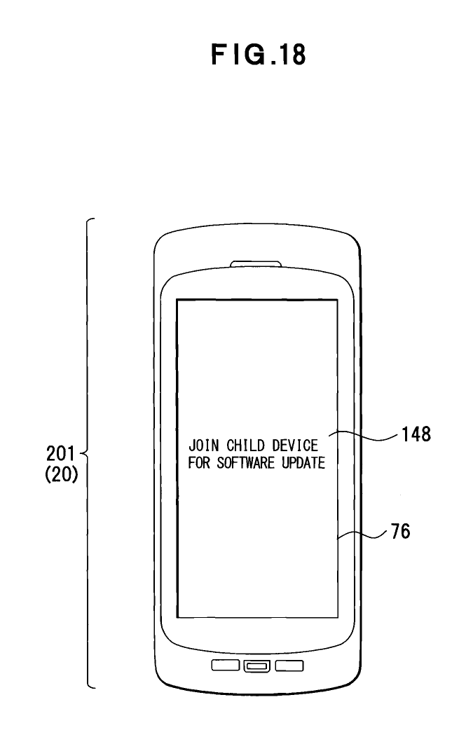

The message display will be described with reference to FIG. 18. FIG. 18 depicts message display in the case of the separated state.

This is the message display when an inconsistency is generated between the version number of the software of the child device 202 and the version number of the software retained by the parent device 201 due to a software update of the parent device 201 etc. In this case, the displaying unit 76 of the parent device 201 in the separated state is driven to generate a message display 148 prompting connection with the child device 202 as depicted in FIG. 18. The message display 148 maybe displayed as “join child device for software update”, for example.

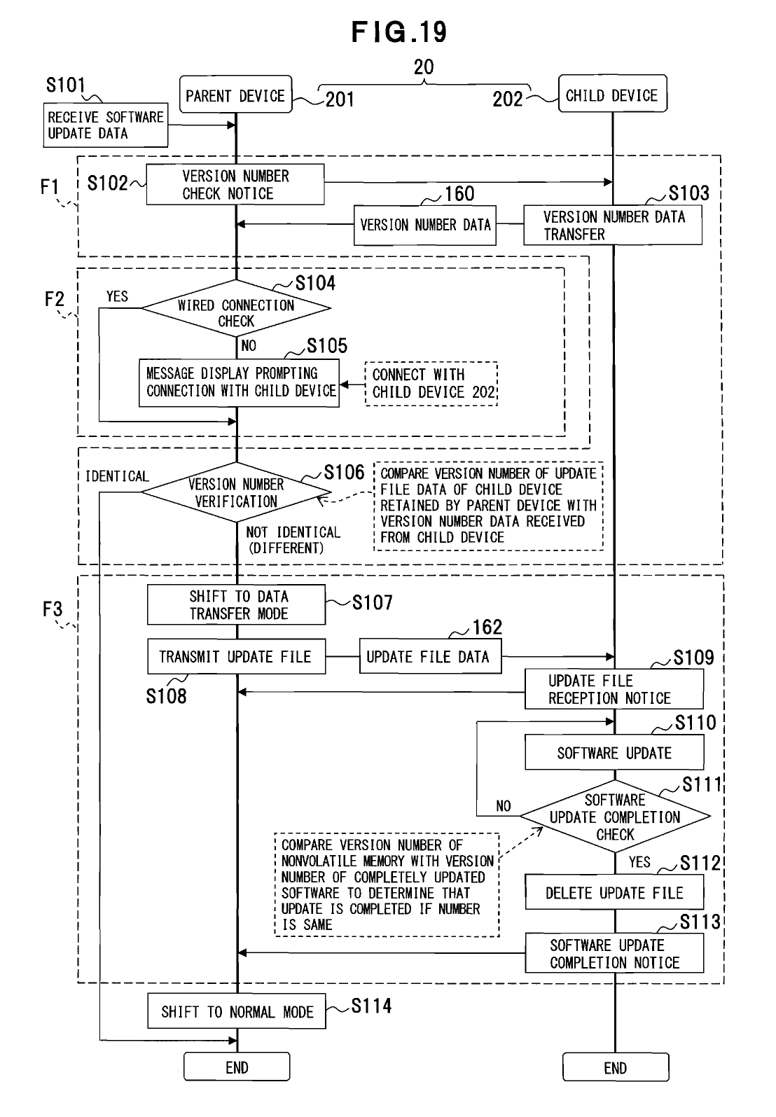

If the child device 202 is joined to the parent device 201 in response to the message display 148, the display can be canceled. If a shift to a data transfer mode (FIG. 19) is triggered by the joining, the software update of the child device 202 can rapidly be performed in accordance with the joining.

The software update of the child device will be described with reference to FIG. 19. FIG. 19 is a flowchart of an example of a software updating function.

This process procedure of the software updating function is an example of a software acquiring method or a software acquiring program of this disclosure and includes a software version number checking function F1, a wired connection checking function F2, and a software updating function F3 as depicted in FIG. 19.

The parent device 201 receives software update data transmitted from a server on the communication network 4 (step S101). The parent device 201 updates the software therein with the received software update data. An update file for updating the software of the child device 202 is stored in the data storage unit 92.

The parent device 201 executing the software update generates a version number check notice for checking the software version number and transmits the version number check notice to the child device 202 (step S102). The child device 202 receives the version number check notice and executes a version number data transfer process (step S103) and version number data 160 is transferred to the parent device 201.

The parent device 201 receives and stores the version number data 160 into the data storage unit 92 (nonvolatile memory). The parent device 201 checks the wired connection (step S104). This wired connection check is a process of determining whether the child device 202 is connected through the wired connection.

If the child device 202 is not connected through the wired connection to the parent device 201 (NO at step S104), the parent device 201 performs message display prompting connection with the child device 202 (step S105). This message display 148 (FIG. 18) may be performed on the displaying unit 76 of the parent device 202 or a message displaying unit different from the displaying unit 76 may be disposed. If the child device 202 is connected through the wired connection to the parent device 201 (YES at step S104), the procedure goes to step S106 without performing the message display.

If the child device 202 is joined to the parent device 201 after the message display, the child device 202 is connected through the wired connection to the parent device 201. After the weird connection or if the wired connection is confirmed by the wired connection check (YES at step S104), the parent device 201 performs version number verification of the software (step S106). This version number verification is a process of comparing the version number of the update file data of the child device 202 retained by the parent device 201 with the version number data 160 received from the child device 202 to determine whether identical or not, i.e., whether a difference occurs in the version number.

If the version number of the software is not identical (not identical at step S106), the parent device 201 turns to the data transfer mode (step S107). In the data transfer mode, the update file read from the data storage unit 92 is transmitted (step S108) and the update file data 162 is transferred to the child device 202.

The child device 202 receiving the update file data 162 stores the update file data 162 into the data storage unit 118 and generates and transmits an update file reception notice to the parent device 201 (step S109). The software update is executed based on the update file data 162 (step S110). In this case, the parent device 201 gives priority to the software update of the child device 202 and stops an event process for the child device 202.

During the execution of the software update, the child device 202 monitors the software update to perform software update completion confirmation (step S111). This software update completion confirmation is a process of comparing the version number data 160 in the data storage unit 118 (nonvolatile memory) with the version number of the completely updated software to determine that the update is completed if the number is the same.

In the software update, the software update mode is continued until the completion is confirmed and if the software update completion confirmation is obtained (YES at step S111), the update file in the data storage unit 118 is deleted (step S112). After the update file is deleted, the child device 202 generates a software update completion notice and transmits the software update completion notice to the parent device 201 (step S113) to terminate the software update process.

The parent device 201 receiving the software update completion notice turns to a normal mode (step S114). In the version number verification (step S106), if the version number of the software of the child device 202 is identical to that of the parent device 201 (identical at step S106), this process is terminated without executing the process from step S107 to step S114.

The advantages and effects of the third embodiment described above will be listed as follows.

(1) Since the separate type portable telephone 20 is separated into the parent device 201 and the child device 202, the version number of the software may not be synchronized and a difference may occur in the version number. Such an inconvenience is eliminated by the above embodiment.

(2) If the software update of the parent device 201 is executed while the parent device 201 and the child device 202 are separated, the message display on the displaying unit 76 of the parent device 201 prompts the software update of the child device 202 and the version number difference of the software between the parent and child devices can be eliminated by executing the update.

(3) Since the child device software update function is added to the separate type portable telephone 20 and an update file of the child device 202 received by the parent device 201 is retained as a portion of data of the parent device 201, the update file is used for the software update of the child device 202.

(4) When the parent device 201 is notified of the version number of the software of the child device 202 through communication between the parent device 201 and the child device 202, the parent device 201 checks a difference in the version number (whether identical or not). If the software version number is different (not identical), message display may be generated that confirms whether the software update of the child device 202 is executed when the wired connection is achieved. If separated, a message prompting connection may be displayed in advance.

(5) For the data transfer mode to the child device 202, the parent device 201 maintains the state that no external event occurs and gives priority to the update file transfer and update process for the child device 202. With this configuration, the reliability of the software update process can be enhanced.

(6) At the time of completion of transfer of update file data to the child device 202, the software update completion notice and the data reception completion notice are transmitted from the child device 202 to the parent device 201. Therefore, the transition of the process procedure can be confirmed.

(7) The child device 202 retains the received update file in a temporarily-retaining data retaining unit, for example, the data storage unit 118 (nonvolatile memory), uses the update file only therein, and changes the version number thereof itself. Therefore, the automatic update of the software is executed.

(8) Since the retained update file is deleted and the parent device 201 is notified of the completion of the update when the software update is completed, a shift to the normal process can be made at this timing.

(9) If the software update is not normally completed due to an event such as removal of a battery, the update file in the data storage unit 118 may be utilized when the child device 202 is activated. In this case, the presence of the file is checked and if the update file exists, the software update of the child device 202 can autonomously and automatically be executed.

(10) If the parent device 201 receives the software update completion notice from the child device 202, the parent device 201 returns to the normal mode. In this case, if separated without the notice from the child device 202, it maybe considered that the software update is failed. In this case, in consideration of a fail-safe, the update file may be transferred again at the time of reconnection until the parent device receives the software update completion notice. The child device 202 may use the update file in the independent state to update the version number only therein. In this case, the version number difference is eliminated at the start of communication between the parent and child devices and the unnecessary of the version number update can be known by the parent device 201.

(11) With the above process procedure, even if the software update of the parent device 201 is executed while the parent device 201 and the child device 202 are separated, the software update of the child device 202 is executed by only transferring the update file from the parent device 201 to the child device 202 and the software version number difference between the parent and child devices can be eliminated.

(12) In the separate type portable telephone 20, because of the addition of the child device software update function described above, if the software update of the parent device 201 is executed, the software update can be automatically executed in the child device 202 having no external communication function except the connection to the parent device 201.

### Fourth Embodiment

A fourth embodiment may be configured to achieve the wired connection after the version number check and to perform a restart after the completion of the update in the case of the software update of the child device 202.

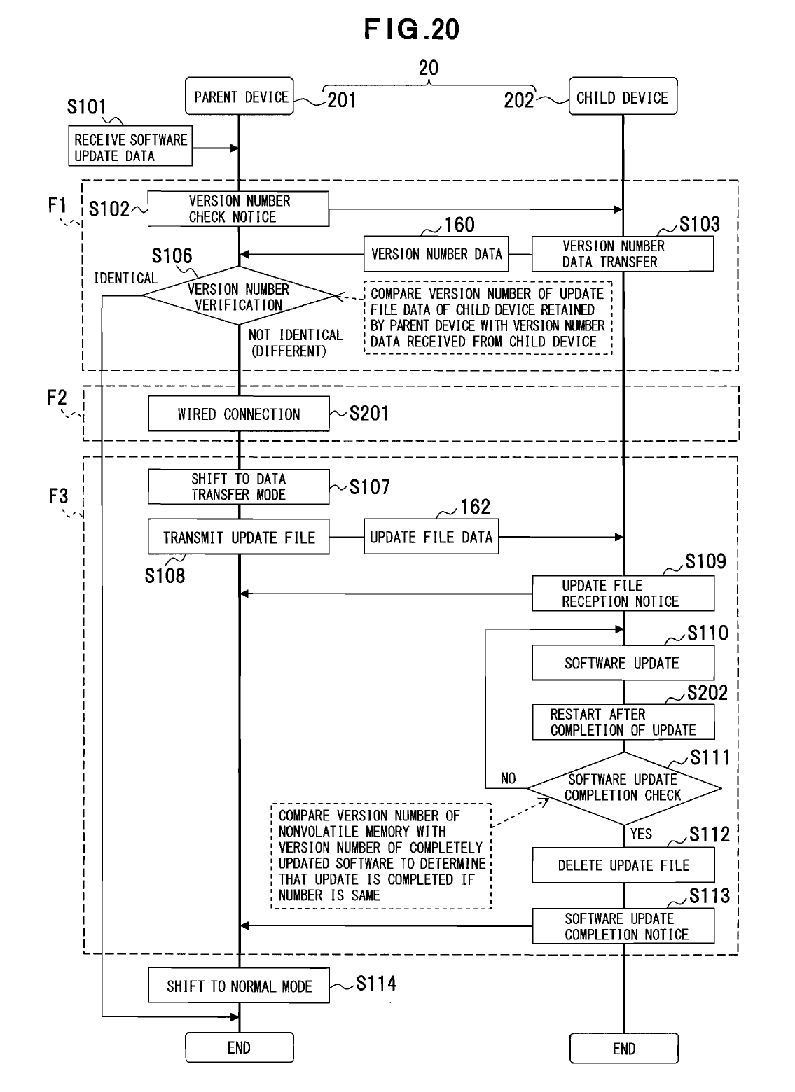

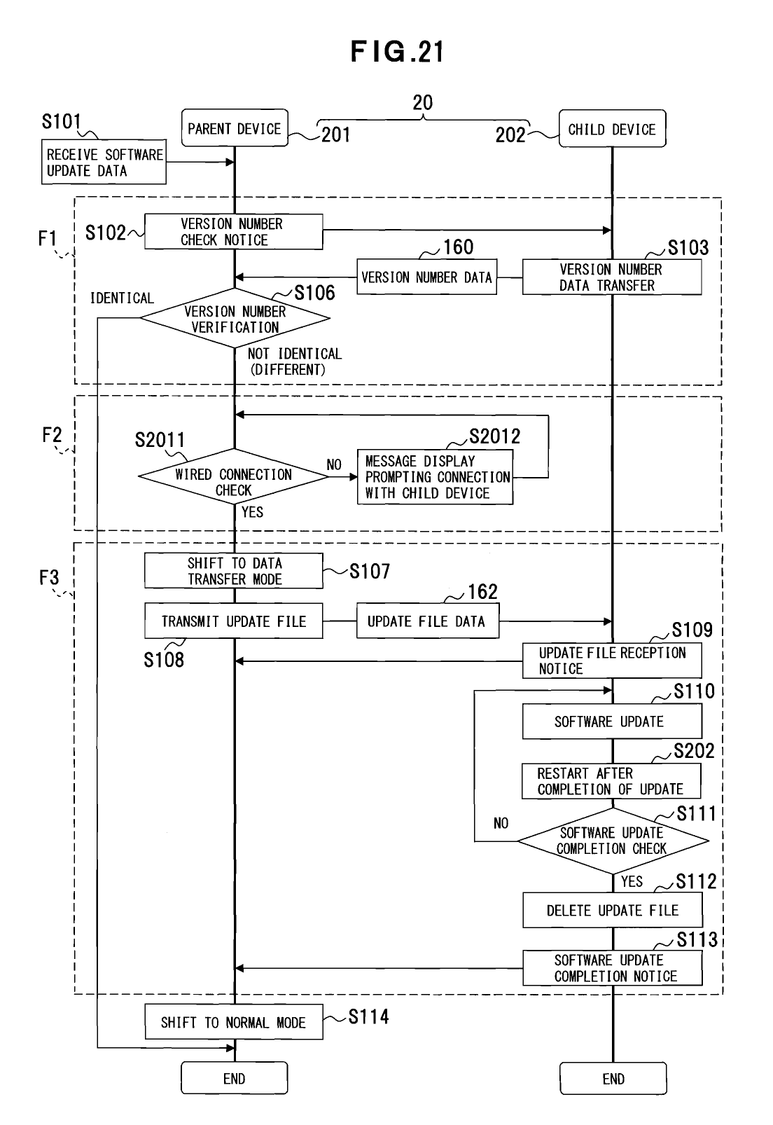

The fourth embodiment will be described with reference to FIGS. 20 and 21. FIG. 20 is a flowchart of an example of the software update function according to the fourth embodiment and FIG. 21 is a flowchart of another example of the software update function. In FIGS. 20 and 21, the same portions as FIG. 19 are denoted by the same reference numerals.

The fourth embodiment uses the same configuration as the third embodiment (FIGS. 5 to 18). Although the wired connection checking function F2 is implemented in the middle of the software version number checking function F1 in the third embodiment, the wired connection checking function F2 is performed after the execution of the checking function F1 in the fourth embodiment. The software updating function F3 is configured to execute a restart process of the child device 202 after the completion of the update following the software update.

In this process procedure, as depicted in FIG. 20, the wired connection is achieved (step S201) after the execution of the checking function F1 and, after the wired connection, a shift is made to the data transfer mode (step S107). After processes of update file transmission (step S108), update file reception notice (step S109) and software update (step S110), the child device 202 is driven to be restarted after the completion of the update (step S202). This restart is an operation of starting up the child device 202 by canceling the energization and then resuming the energization at the timing of the completion of the software update.

With regard to a process procedure of the software update, in the wired connection (step S201), as depicted in FIG. 21, the wired connection is checked (step S2011) and if the wired connection is not achieved (NO at step S2011), the message display 148 (FIG. 18) prompting connection with the child device 202 is performed to continue the wired connection check. With this configuration, the procedure of the shift to the software update can be performed.

If the wired connection is confirmed (YES at step S2011), a shift is made to the software updating function F3 described above. This software updating function is the same as the process procedure described above (FIG. 20).

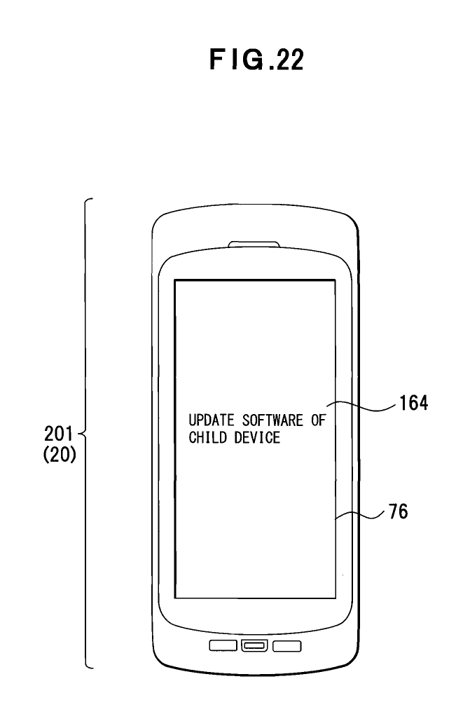

(1) Although the display prompting the connection between the parent and child devices is performed before the software update in the embodiments, this is not a limitation. If the software of the parent device 201 is updated, message display 164 prompting the software update of the child device 202 may be performed or a message of whether the update is executed may be displayed. The message display 164 prompting the software update may be displayed as “update software of child device”, as depicted in FIG. 22, for example.

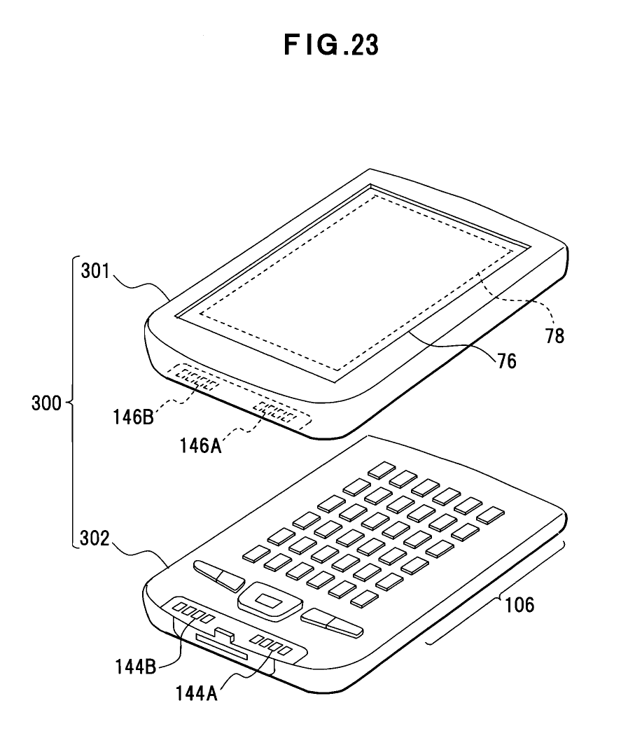

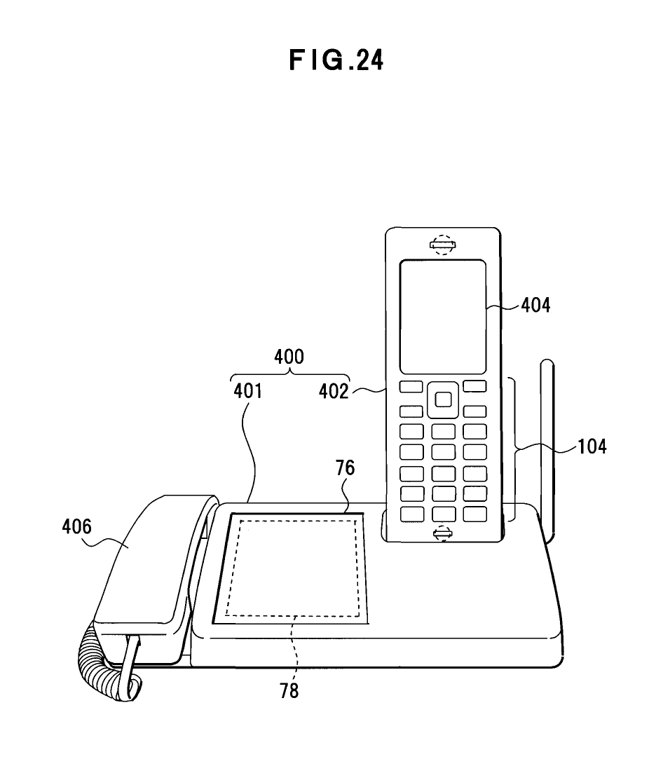

(2) Although the above embodiments exemplarily illustrate the separate type portable telephone 20 as a communication terminal apparatus separated into a parent device and a child device, this is not a limitation. For example, a personal digital assistant (PDA) 300 (FIG. 23) or a separate type telephone 400 (FIG. 24) may be used.

If the PDA 300 is separated into a parent device 301 and a child device 302 as depicted in FIG. 23 and is configured as is the case with the above embodiments, the functions such as software update of the child device 302 can be implemented. In FIG. 23, the portions same as the above embodiments are denoted by the same reference numerals and will not be described.

If the separate type telephone 400 is separated into a parent device 401 and a child device 402 as depicted in FIG. 24 and is configured as is the case with the above embodiments, the functions such as software update of the child device 402 can be implemented. In FIG. 24, the portions same as the above embodiments are denoted by the same reference numerals and will not be described. In this example, the child device 402 includes a displaying unit 404. The parent device 401 includes a handset 406.

(3) Although the Bluetooth communication is utilized as the short-range communication connection for the wireless connection in the above embodiments, the wireless connection is not limited to the Bluetooth communication connection. Other communication standards or wireless mediums may be utilized.

(4) Although the software version number check is performed by issuing the version number check notice to the child device 202 and receiving the transfer of version number data from the child device 202 for the version number check in the above embodiments, this is not a limitation. Although the above embodiments have been described by an example with the parent device 21 including the version number checking unit 5 and the connection checking unit 7, this is not a limitation. These constituent elements maybe included in the child device 22 and the child device 22 may play a leading role.

(5) Although the software update is executed when the parent device 201 and the child device 202 achieve the wired connection in the above embodiments, the software update maybe executed in the wireless connection state. In this case, the connection state may be switched to the wired connection or the wireless connection depending on the size of the update file and the update may be executed through the wired connection if the update file is large.

(6) Although the child device 202 (FIGS. 13, 15, and 16) of the above embodiments is not provided with a displaying unit, the child device 202 may be provided with a displaying unit.

(7) Although the above embodiments have been described by an example with the child device 202 including the file update control unit 58 for executing the software update of the child device 202, this file update control unit may be included in the parent device 201.

(8) Although the child device 202 stores the update file in the data storage unit 118 as a memory in the above embodiments, this is not a limitation. An update file storage unit may be set as the third memory in the data storage unit 118 or the storage unit 102 to store the update file in this update file storage unit and the software may be updated based on the update file read from the third memory. The third memory may be an external memory attached to and detached from the child device 202.

### Fifth Embodiment

A fifth embodiment may be configured to automatically update software of a child device if a parent device and the child device achieve the wireless connection.

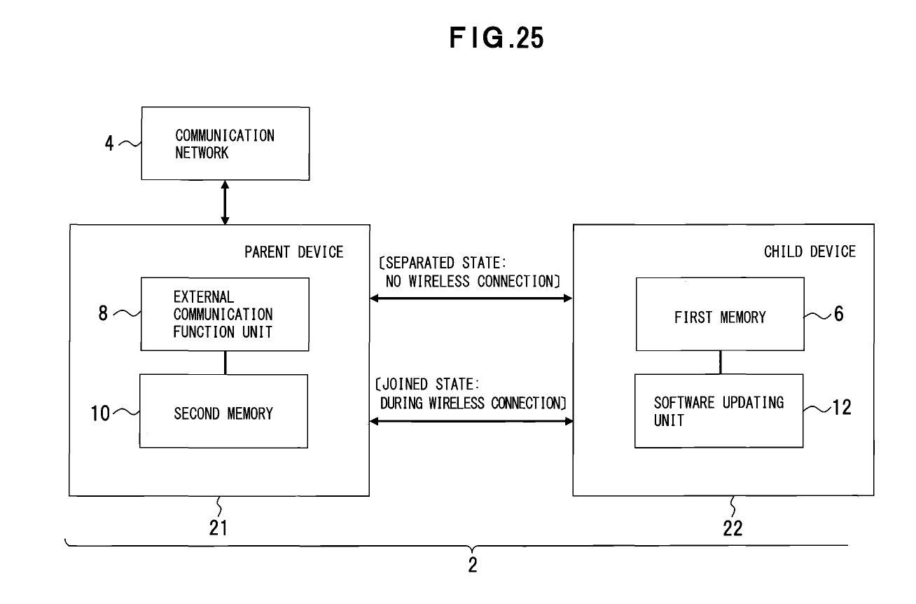

The fifth embodiment will be described with reference to FIG. 25. FIG. 25 is a diagram of functional units of a communication terminal apparatus. The configuration depicted in FIG. 25 is an example and the present disclosure is not limited to this configuration.

This communication terminal apparatus 2 is an example of a communication terminal apparatus of this disclosure. The communication terminal apparatus 2 depicted in FIG. 1 is detachably separated into the parent device 21 which is a second apparatus and a child device 22 which is a first apparatus. A joined state used in this embodiment means a state where the parent device 21 and the child device 22 are wirelessly connected so as to be able to communicate with each other. A separated state used therein means a state where a wireless communication between the parent device 21 and the child device 22 is not achieved because both of the devices are separated or the power supply of either one of the both is not turned on.

The software updating unit 12 updates software based on an update file read from the memory 10 when the parent device 21 acquires an update file and the parent device 21 and the child device 22 are wirelessly connected. Other points except the above are the same as FIG. 1, and descriptions thereof will be omitted.

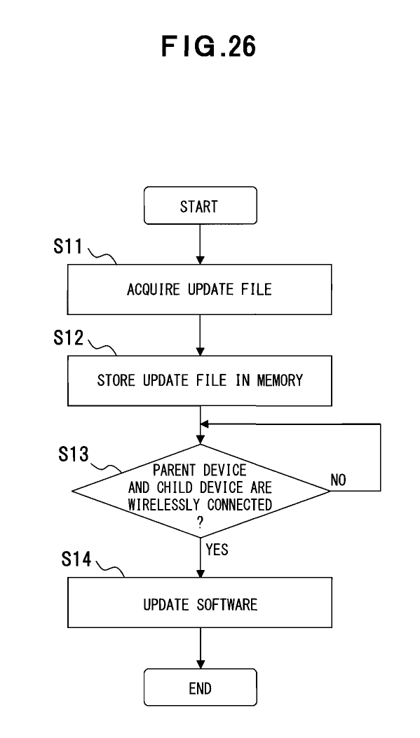

A process procedure of the software update will be described with reference to FIG. 26. FIG. 26 is a flowchart of an example of a process procedure of the software update.

This process procedure is an example of execution of a software acquiring method or a software acquiring program of this disclosure. As depicted in FIG. 26, this process procedure includes an update file acquiring function (step S11), an update file storage function (step S12), a connection checking function (step S13) and a software updating function (step S14).

These function almost the same as the descriptions about FIG. 2, and descriptions thereof will be omitted. The connection checking function (step S13) in this embodiment is a process of monitoring whether the parent device 21 and the child device 22 are wirelessly connected. If the parent device 21 and the child device 22 are wirelessly connected, the software updating unit 12 updates a file in the child device 22 as exemplified in FIG. 2 (step S14).

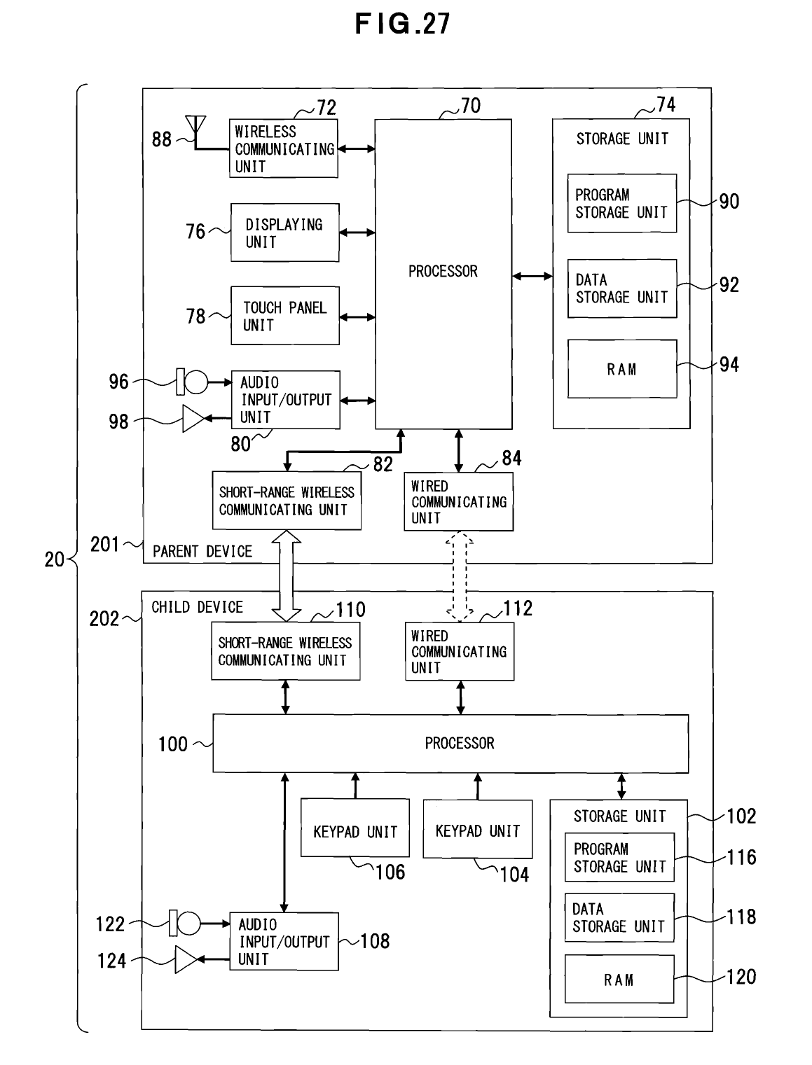

A configuration of hardware of a communication terminal apparatus of the embodiment will be described with reference to FIG. 27. The configuration of the hardware in FIG. 27 is almost the same as that depicted in FIG. 8. The configuration in FIG. 27 is different from that of FIG. 8 in the joining/separation detecting units 86 and 114, existing in FIG. 8, not existing.

In the embodiment illustrated in FIG. 8, whether the parent device 201 and the child device 202 are in the joined state or the separated state is determined by the presence of the physical coupling state between the both. On the contrary, in this embodiment, whether the parent device 201 and the child device 202 are in the joined state or the separated state is determined by the presence of the wireless connection between the both. For example, the joined state of the parent device 201 and the child device 202 is determined by the processor 70 monitoring the state of the short-range wireless communicating unit 82.

### Other Embodiments

In the above described embodiments, the separate type portable telephone separated into the parent device and the child device or the like was described as an example. A device which the present embodiments are applied to is not limited thereto.

For example, a mobile phone that can be connected to a mobile phone network is assumed to be a second apparatus and a video projector, an automotive navigation system, etc. that do not have the function for communicating with an external device other than the second apparatus is assumed to be a first apparatus. The first apparatus is a video projector that receives information from a mobile phone by being connected to the mobile phone and projects the received information, an automotive navigation system, which acquires the latest map information from a center server by being connected to a mobile phone and so on. Such devices have an interface for executing communication by a mobile phone being connected. However, many of the devices do not have means for directly connecting to a mobile phone network etc. In this case, a mobile phone downloads a software updating program to be executed in the first apparatus via a mobile phone network from a management center server to store the down loaded program. When the first apparatus and the mobile phone are in a connection state, the first apparatus can update the software using the updating program.

A video projector and an automotive navigation system implement various functions by a processor thereof reading out and executing programs stored in a memory. Therefore, it is desirable that programs and data can be updated easily as is the case with a mobile phone. However, since the above devices do not have the function for communicating with an external device as is the case with a child device of a mobile phone, it is difficult to acquire updating data. When the present disclosure is applied to such devices, simple mechanism for an automatic update can be formed without extra operation by a user since update data can be automatically acquired only by such devices to be connected to a mobile phone, which is the parent device according to the present disclosure.

In a case of a video projector, consistency of software to be executed by the video projector and a mobile phone is very important since data is transmitted to and received from the mobile phone. When there is a difference in the version numbers of software of the both, malfunction may occur in data transmission and reception. In a case of an automotive navigation system, it may occur that during route guidance, the latest map information corresponding to a position to be displayed next is acquired from a center server. In this case, interactive data transmission and reception is executed that information of a position to be displayed next is transmitted from the automotive navigation system to a mobile phone and the map information acquired from the center server is transmitted from the mobile phone to the automotive navigation system. Thus, consistency of software to be executed by the both is also very important in this case. Like the above, there is especially an advantage to apply the present disclosure to interactive executed software achieving a process by cooperating with each other as described above.

Like the above, the present disclosure is applicable to devices of, for example, having a second apparatus that has a function for communication with the outside and a first apparatus connected to the second apparatus, in which the first apparatus does not have a function for communicating with an external device other than the second apparatus.

Updating software that the child device retains was described as an example in the above embodiments. The present disclosure is not limited to such an updating process. For example, it may occur that a new programming module is added for adding a function to software of the child device. It may also occur to install new software into the child device. In these cases, the parent device acquires a new programming module and software from a software distribution server etc. and stores them to a memory therein. When the child device and the parent device are connected, the child device stores the new programming module and software into a memory therein and installs them thereinto. Thereby, the child device can implement the programming module and software.

Technical ideas extracted from the embodiments including the example described above will then be listed. The technical ideas of the present disclosure may be comprehended at various levels and variations ranging from higher to lower conceptions and the present disclosure is not limited to the following description.

A communication terminal apparatus detachably separated into a parent device and a child device, the parent device and the child device in a separated state being wirelessly connected through short-range communication, the communication terminal apparatus includes a first memory disposed in the child device and having stored thereon software for communicating with the parent device; an external communication functional unit that is disposed in the parent device and acquires an update file related to the software from an outside; a second memory disposed in the parent device and having the update file stored thereon; and a software updating unit that updates the software based on the update file read from the second memory when the update file is acquired and the parent device and the child device are connected.

Preferably, the above communication terminal apparatus may include a message output unit that outputs a message prompting connection between the parent device and the child device when the external communication functional unit acquires the update file.

In the above communication terminal apparatus, preferably, at time of updating the software of the child device, the software updating unit may set the child device in a wired connection state to a data transfer mode to define the data transfer mode as a priority process.

Preferably, the above communication terminal apparatus may include a third memory disposed in the child device and having the update file stored thereon, wherein the software updating unit updates the software based on the update file read from the third memory.

A software updating method performed by a communication terminal apparatus detachably separated into a parent device and a child device, the parent device and the child device in a separated state being wirelessly connected through short-range communication, the method includes acquiring an update file related to the software for communicating with the parent device from an outside; storing the update file into a memory; and updating the software based on the update file read from the memory when the update file is acquired and the parent device and the child device are connected.

A computer-readable recording medium storing a software updating program to be executed by a communication terminal apparatus detachably separated into a parent device and a child device, the parent device and the child device in a separated state being wirelessly connected through short-range communication, the program operable to drive the communication terminal apparatus to execute: storing software for communicating with the parent device in a first memory of the child device; acquiring an update file related to the software from an outside; storing the update file into a second memory of the parent device; and updating the software based on the update file read from the second memory when the update file is acquired and the parent device and the child device are connected.

The program implementing the embodiments may be recorded on computer-readable media comprising computer-readable recording media. The program implementing the embodiment s may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

The communication terminal apparatus, the software acquiring method and the recording medium of this disclosure eliminate occurrence of a software version number difference in a child device by the automatic update of software if the software update is executed in a parent device while the parent device and the child device are separated, add a new function to the child device, and are widely available in electronic devices separated into parent and child devices. Thus, they are useful.

What is claimed is:

1. A communication terminal apparatus including a second apparatus having a communication function and a first apparatus connectable to the second apparatus, the communication terminal apparatus comprising
an external communication function unit that is disposed in the second apparatus and acquires software, which is executable in the first apparatus, from an outside;
a second memory that is disposed in the second apparatus and stores the software which is acquired;
a first memory that is disposed in the first apparatus; and
a storage unit that is disposed in the first apparatus and stores the software read out from the second memory to the first memory according to a connection between the first apparatus and the second apparatus.

2. The communication terminal apparatus of claim 1, wherein the first apparatus includes a software updating unit that updates existing software by using the software which is stored, the existing software having been retained by the first apparatus.

3. The communication terminal apparatus of claim 1, wherein
the second apparatus includes a version number checking unit that compares a version number of existing software which corresponds to the software and has been retained by the first apparatus with a version number of existing software which corresponds to the software and has been retained by the second apparatus, and
the first apparatus includes a software updating unit that updates existing software according to a comparison result by the version number checking unit, the existing software having been retained by the first apparatus.

4. A software acquiring method performed by a communication terminal apparatus including a second apparatus having a communication function and a first apparatus connectable to the second apparatus, comprising:
acquiring, by the second apparatus, software, which is executable in the first apparatus, from an outside;
storing, by the second apparatus, the software which is acquired to a second memory; and
storing, by the first apparatus, the software read out from the second memory to the first memory included in the first apparatus according to a connection between the first apparatus and the second apparatus.

5. The software acquiring method of claim 4, further comprising:
updating, by the first apparatus, existing software by using the software which is stored, the existing software having been retained by the first apparatus.

6. The software acquiring method of claim 4 further comprising:
comparing, by the second apparatus, a version number of existing software which corresponds to the software and has been retained by the first apparatus with a version number of existing software which corresponds to the software and has been retained by the second apparatus, and
updating existing software according to a comparison result, the existing software having been retained by the first apparatus.

7. A computer-readable recording medium storing a software acquiring program to be executed by a communication terminal apparatus including a second apparatus having a communication function and a first apparatus connectable to the second apparatus, the program causing the communication terminal apparatus to perform a method, the method comprising:
acquiring, by the second apparatus, software, which is executable in the first apparatus, from an outside;
storing, by the second apparatus, the software which is acquired to a second memory; and
storing, by the first apparatus, the software read out from the second memory to the first memory included in the first apparatus according to a connection between the first apparatus and the second apparatus.

8. The recording medium of claim 7, the method further comprising:
updating, by the first apparatus, existing software by using the software which is stored, the existing software having been retained by the first apparatus.

9. The recording medium of claim 7, the method further comprising:
comparing, by the second apparatus, a version number of existing software which corresponds to the software and has been retained by the first apparatus with a version number of existing software which corresponds to the software and has been retained by the second apparatus, and
updating existing software according to a comparison result, the existing software having been retained by the first apparatus.
